(19) United States
(12) Patent Application Publication
(10) Pub. No.: US 2003/0106858 A1
(43) Pub. Date: Jun. 12, 2003

(54) Separation of solid particulate materials from fluid streams

(75) Inventor: John Ernest Elsom Sharpe, North Coker (GB)

Correspondence Address: NIXON & VANDERHYE, PC, 1100 N GLEBE ROAD, 8TH FLOOR, ARLINGTON, VA, 22201-4714, US

(73) Assignee: BTG International Limited.

(21) Appl. No.: 10/347,598

(22) Filed: Jan. 22, 2003

Related U.S. Application Data
(63) Continuation of application No. 09/508,060, filed on Mar. 7, 2000, now abandoned.
Application No. 09/508,060 is a 371 of international application No. PCT/GB98/03258, filed on Nov. 2, 1998.

(30) Foreign Application Priority Data
Nov. 1, 1997 (GB) 9723029.6

(51) Int. Cl. B01D 17/038

(52) U.S. Cl. 210/787; 210/805; 210/512.1; 55/459.1

(57) ABSTRACT

A method of separating particulate material from a fluid stream comprises rotating in the fluid stream (10) a perforated barrier (1) which permits the fluid to pass through it, the axis of rotation of the barrier projecting into the fluid stream, and the front surface of the perforated barrier being substantially normal to the streamlines in a major part of the incoming flow at the points where the flow meets the barrier, particles (2) colliding with the barrier being in consequence imparted with kinetic energy in a tangential direction so that they travel towards the periphery of the perforated barrier entrained in a diverted portion of the fluid stream

This invention relates to a method and device for separating particulate materials from fluid streams.

The term fluid in the context of the present invention includes both gaseous fluids and liquid fluids.

In many-situations the ability of a fluid stream to carry particulate material with it may be beneficial and this ability may be used for example for the transport of materials, which may be useful commodities or waste, from one location to another where the fluid must be efficiently separated from the particulate material. In other situations, particulate material may be an undesirable constituent of a fluid stream and should therefore be removed before the fluid is introduced, for example, into engines and machinery or into industrial processes, or into the environment, whether it be the environment at large or a closed environment such as an office building.

An important application of separation methods is in the field of removal of particulate waste materials in, for example, homes, gardens, offices, workshops and factories involving so-called vacuum cleaning techniques, either in dedicated cleaning equipment or as an adjunct to other equipment whose operation causes particulate waste to be formed. Other important applications are in the field of systems which produce particulate-bearing waste gases and liquids which must be treated in order to comply with emission criteria, for example diesel and other internal and external combustion engines, various industrial processes, and waste disposal operations.

Separation applications involving the use of liquids as a fluid include, for example, sand dredgers and the disposal of liquid waste.

It will accordingly be-seen from the disclosure hereinafter that the potential separation applications to which the present invention can be applied are very wide-ranging, and include many that are not specifically mentioned above but to which the invention is equally applicable.

There is growing concern about filtration standards and there have been new developments in vacuum cleaner technology to provide higher levels of filtration without the need to use ever finer filters but by the use of very efficient cyclones. Such cyclones cannot of themselves assure the size of particle that has been removed from the fluid stream. This can only be achieved by passing the fluid through a porous medium having pores of a size prescribed to eliminate larger particles.

However, such porous media quickly become blocked and therefore large areas of such media are required in order to give an acceptable period of use before they have to be cleaned. A domestic vacuum cleaner is one example; the blockage of the cooling duct inlet of certain electrically powered railway trains by fine snow is another; also air-conditioning filters are examples which occur readily to mind.

There is therefore an existing problem concerning the efficiency of conventional filtration systems both in respect of the life of the filters and the efficiency of the filtration process itself. There is in particular a need for a process which can more effectively remove solid particulate materials from the vicinity of the front face of the filter, which maintains the filter in a clean condition, which does not involve such frequent stoppages in the separation process, which is more compact and uses a smaller surface area of filter than previous devices which have attempted to solve such problems, and which is able to guide separated particles in a controlled stream to a place where they can be further processed.

Proposals have previously been made to use rotating filters. However, such prior devices have been inefficient in practice either by virtue of their structure, the amount or area of filter which may be required, or their mode of operation, and there remains a need for an efficient method of separating solid particulate material from fluid flows which avoids the problems mentioned above.

According to the present invention there is provided a method of separating particulate material from a fluid stream which method comprises rotating in the fluid stream a perforated barrier which permits the fluid to pass through it, the axis of rotation of the barrier projecting into the fluid stream, and the front of the perforated barrier being substantially normal to the streamlines in a major part of the incoming flow at the points where the flow meets the barrier, particles colliding with the barrier being in consequence imparted with kinetic energy in a tangential direction so that they travel towards the periphery of the perforated barrier entrained in a diverted portion of the fluid stream. Preferably the said diverted portion of the fluid stream is guided to a place where it is separate from the vicinity of the rotating front surface of the perforated barrier so that separated particles in the said diverted portion of the stream are not caught up in the fluid stream which is approaching the rotating barrier.

It is also a preferred feature of the invention that a portion of the fluid stream which has passed through the perforated barrier is fed back around the barrier to join the diverted portion of the fluid stream containing the entrained separated particulate material.

The invention further provides a device for separating particulate material from a fluid stream, which device comprises:

a duct for conveying a fluid stream containing entrained particulate material;

a perforated barrier which is mounted for rotation in the duct about an axis which projects into the fluid flow, said perforated barrier permitting fluid flow through it, the front of the barrier being arranged in the duct so that it is substantially normal to the streamlines in a major part of the incoming flow at the points where the flow meets the barrier; and

means for rotating the perforated barrier.

Preferably, the device further comprises a means for guiding a diverted portion of the fluid stream which contains particles which have collided with the front of the barrier and in consequence have been imparted with kinetic energy in a tangential direction by the rotation of the barrier, so that said particles are entrained in said diverted portion of the fluid stream at the periphery of said surface; said guiding means being arranged to guide said diverted portion of the stream to a place separate from the vicinity of the rotating front surface of the barrier so that separated particles in said diverted portion of the stream are not caught up in the fluid stream which is approaching the rotating barrier.

By major part of the incoming flow is meant more than 50% by volume of the incoming flow.

One of the essential features of the present invention is that the separation of the particulate material is due not only to the limited size of openings in the rotating barrier but also to particles colliding with the rotating barrier and in consequence being imparted with kinetic energy in a tangential direction as the fluid stream meets the front of the rotating barrier. That is, the present invention combines the conventional filtration technique of using a barrier containing apertures through which only particles of a certain maximum size may pass, with a technique in which rotational kinetic energy given to the barrier is transferred to particles in the fluid stream so that the particles together with a part of the fluid, perhaps 5% to 10%, are given sufficient kinetic energy in the direction of rotation of the barrier to thus be driven outward from the axis of rotation of the barrier towards the circumference of the perforated part of the barrier so as to separate them from the main fluid stream, perhaps 90% to 95% of the original stream, which passes through the barrier together with the remainder of very small particles which are able to pass through the perforations in the barrier. Thus, the present invention combines conventional barrier filtration with the use of an imposed tangential force to produce a relative separation of particulate material from a fluid in a controlled manner.

It will be understood that in order to arrange for the fluid stream containing the particulate matter to meet the front of the rotating barrier normally the barrier will usually be rotated in a plane normal to the fluid stream, although this is not absolutely essential.

The particulate material which is to be separated by the method and device of this invention will usually be solid particulate material. However, it will be appreciated that in some situations the particles will perhaps, for example, have a relatively high liquid content and may be capable of description as say semi-solid or some other description which might not strictly be regarded as a solid but which nevertheless is particulate material which is able to be separated by the method and device of the invention.

The perforated barrier may be made like a conventional filter, for example of porous metal, sintered metal, porous ceramic material, woven or non-woven fibres, fibre bundles, tube bundles or any other conventional filter material. However, it is not essential that the perforated barrier be of such construction, as long as it permits fluid flow through it. Thus, for example, it could be in the form of a multi-spoked or multi-bladed wheel, a fundamental requirement of the rotating perforated barrier being that it has sufficient surface area facing the fluid stream in order to strike a high proportion of the solid particles conveyed in the stream and thus cause them to be carried by tangential force radially away from the perforated front surface of the barrier and thus to physically separate them from the main fluid flow which passes through the body. It will be seen that this mechanism allows the passageways through the barrier to remain unblocked. The size of the passageways or pores through the barrier are of course relevant to the size of the particulate material which can be separated. However, it has been found that the pore size can be for example 100 mμ and surprisingly using the method of the invention about 98% of particles 5 mμ size are separated, that is a pore to particle size ratio of 20 to 1. Thus, not only is the present invention able to substantially remove much smaller particles than the fineness of the filter would indicate but this enables a coarser filter to be used which is also maintained in a clean and efficient state for a much longer period of time by using the method of the invention. Another advantage of the present invention is that the area of filter material which is required is much smaller than in prior devices due to the structure and method of use of the device. The present invention is particularly suitable for removing particles in size ranges including about 2.5 μm which have in the past been a problem in causing clogging of conventional filters.

One feature of the operation of the invention is that particulate material in the stream which meets the rotating barrier at its axis of rotation will not tend to be driven outwards, at least immediately, because of the low tangential kinetic and centrifugal forces at this point and it tends to build up to a small hyperbolic mound. This can be avoided by blanking off the surface of porous material at the axial point of the rotating body, for example preferably with paint or varnish.

The actual structure of the perforated barrier may be such that it contains porous material only in its central area, and the periphery may be of any suitable material and may serve as a container for the porous material.

A preferred shape for the barrier is a disc which may have a flat or curved face, and may be convex, conical, ovoid, dome, or bullet-shaped or any other suitable shape which permits the separated particulate material to be hit clear of the face of the barrier and preferably guided so that it does not become caught up in or interfere with fresh incoming fluid to prevent it from passing through the barrier.

Although, as is explained above, the rotating perforated barrier is not necessarily in the form of a conventional filter, for the sake of convenience the barrier will be referred to hereafter in this description as a filter.

Preferably, when the fluid containing the particulate material is not already in motion as a stream, the means for causing rotation of the filter also includes means for inducing the flow of the fluid stream. Conveniently in this situation the filter is formed integrally with or joined to, for example, the impeller of a turbo machine or other arrangement in the fluid duct in order to induce fluid flow, which can be positioned either in front of or to the rear of the filter in respect of the fluid flow. The power means for giving rotation may conveniently be an electric motor but in the application of the present invention for example to engines, chemical plant or other processes other motive power may be available which may be more convenient or economic to use.

The manner in which the diverted portion of the fluid stream containing separated particles is guided and handled immediately after it has been struck sideways off the revolving filter will depend on the particular application to which the invention is put. However, in many situations it will be desirable to arrange a circumferential shroud around the periphery of the filter, which may be either fixed or may rotate with the filter, and extending in front of the filter so as to form a gap into which the diverted portion of the fluid stream together with separated particles is guided, and from which the diverted flow may be conducted for example to a chamber where most of the particles can be separated for example by gravity, or by magnetic or centrifugal force, from the fluid which may then, for example, be re-combined with the main fluid flow, either before the main flow has been subject to the separation step, or after, depending on the application. Alternatively, the diverted portion of the flow with the separated particles still entrained therein may be introduced into a chemical or physical process for transforming the particles.

Optionally two or more of the separation steps of the invention may be arranged in cascade in order to provide yet finer separation.

As indicated previously, an important and very useful application of the present invention is in the field of removal of waste particulate materials which are at present handled by various forms of vacuum cleaning technique. It will be seen that the present invention offers a way of improving such techniques by substituting a rotating perforated barrier of the invention for the conventional filters used in such equipment and in many cases the change of design in relation to existing equipment is relatively minor but confers considerable benefits. Such existing equipment already incorporates appropriate motive power, usually in the form of an electric motor, coupled to some form of impeller to induce the fluid flow, as well as having a collection means for separated particulate waste. A rotating fluid-permeable perforated barrier of the invention needs therefore only to be coupled to the impeller of the device in the duct for the fluid stream and the existing static filter removed, in order to make use of the present invention.

Thus, for example, a conventional electric battery-powered hand-held vacuum cleaner type device such as of the “Dustbuster” (Trade Mark) type which is itself a very efficient device of its kind, can be adapted as mentioned above to use the present invention. A specific adaptation of this device is described hereinafter.

Other types of vacuum cleaner which are designed for higher volumes of particulate waste include the so-called bucket or cylinder type whose common features comprise a cylinder or other container which incorporates an air inlet to which a collector hose is attached and an electrically powered impeller having in front of it one or more conventional filters being arranged to catch the particulate waste, at least one of said filters often being in the form of a porous bag. It will be seen that such a general arrangement can readily be adapted by using a device of the present invention in which the impeller is coupled to a fluid permeable barrier of the invention in order to rotate it and thus provide a separation of the particulate waste, which may for example be diverted back along with the diverted portion of the air flow within the body of the container and collected at the bottom of the container.

A variation of the bucket vacuum cleaner is a carpet shampooer. In this type of cleaner it is arranged for carpet shampoo to be sprayed onto the carpet from near the end of the collector hose. In this case the hose conducts solid particulate waste in an airstream which contains liquid back to the container. In this case also, as is other cases where a gaseous fluid may contain liquid particles a conventional “thrower” device can be fitted on the front of the rotatable filter. The thrower is a solid disc which, as the name implies, rotates and throws liquid particles which are present in the gaseous stream to the side thus reducing or eliminating the amount of liquid which reaches the filter itself and which may cause possible blockage problems when mixed with the particulate material.

It will be understood that there are other apparatus in which it may be desirable to introduce a liquid into the main gaseous fluid stream and in such situations it may or may not be necessary or desirable to incorporate a thrower device before the rotating filter.

An additional or alternative feature which may be included in such vacuum cleaning equipment is a pre-shredder, in other words a rotating blade arrangement fitted on the front of the rotating filter body which can cause some size reduction in the particulate waste before it reaches the filter face itself and thus make the particulate material more manageable.

Another variation of the vacuum cleaner is the garden vacuum cleaner which is used to remove leaves and other garden debris. Such a cleaner can use the device of the invention in a similar manner as described before but optionally with a useful variation in that the main stream of air produced by the impeller can be ducted to a point near the inlet of the collecting hose in order to dislodge debris which is then sucked into the collecting hose. Liquid such as water or other treatments, either fluids or particulate matter, can if desired by introduced into the pressurized air stream. It will be seen that this kind of arrangement can also be used in a carpet shampooer so that water or carpet shampoo solution is introduced into the high pressure stream in order to carry the shampoo deep into the carpet pile.

As mentioned above, in addition to dedicated cleaning devices there is also a need for efficient cleaning devices as adjuncts to other types of equipment which produce particles as a by-product of their operation, for example, mechanical sanders, polishers, and woodworking machinery. Accordingly, it is to be understood that the present invention extends to any such types of equipment when they incorporate as a means for removal of particulate matter a device in accord with the present invention.

It has previously been mentioned that the device of the invention can be applied to the removal of particles from the exhaust gases of combustion engines and other processes. It will be apparent from the previous description that this may be done by carrying the diverted portion of the fluid stream, in this case the gaseous exhaust containing a significant proportion of carbon-based particles, to a separate receptacle where they can be removed by conventional means, for example, by gravity or centrifugal force. However, this diverted stream containing the carbon particles may also be added to the inlet air of the engine so that the-particles are combusted or otherwise processed by chemical or physical reaction.

Additionally, it will be understood that the device of the invention can be employed in any chemical or industrial process or equipment in which particulate material needs to be separated from a fluid and in which the techniques previously mentioned can be used, for example separation of the particles from the diverted stream, recycling of the diverted stream to the main stream and removal of pollutant particles from exhaust gases and liquids, including air and liquid conditioning equipment, and reacting them subsequently to render them innocuous.

The invention will now be described by way of example with reference to the accompanying drawings in which:

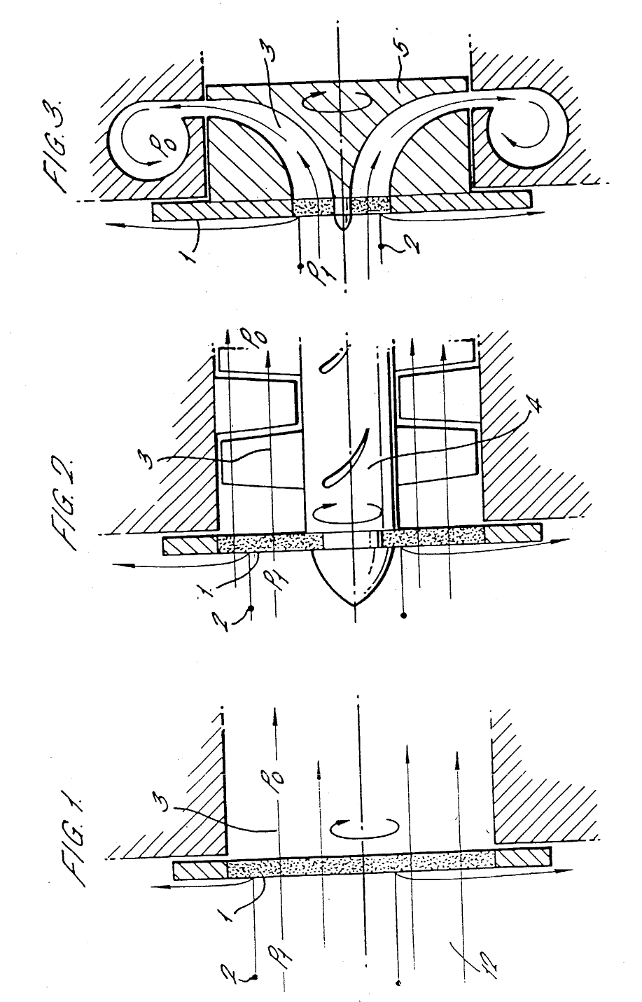

FIG. 1 is a diagrammatic representation in section of the operation of the device of the invention;

FIG. 2 is a diagrammatic representation in section of the device of FIG. 1 in which the filter incorporates an integral axial turbo machine for producing fluid flow;

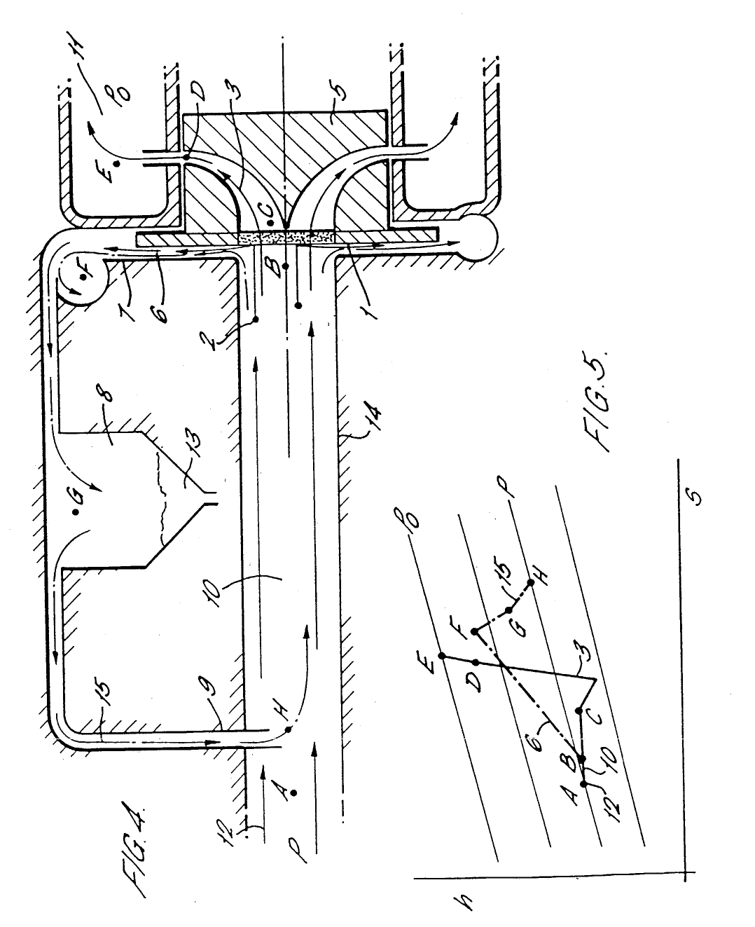

FIG. 3 is a diagrammatic representation in section for the device of FIG. 1 in which the filter incorporates a centrifugal turbo machine for producing fluid flow;

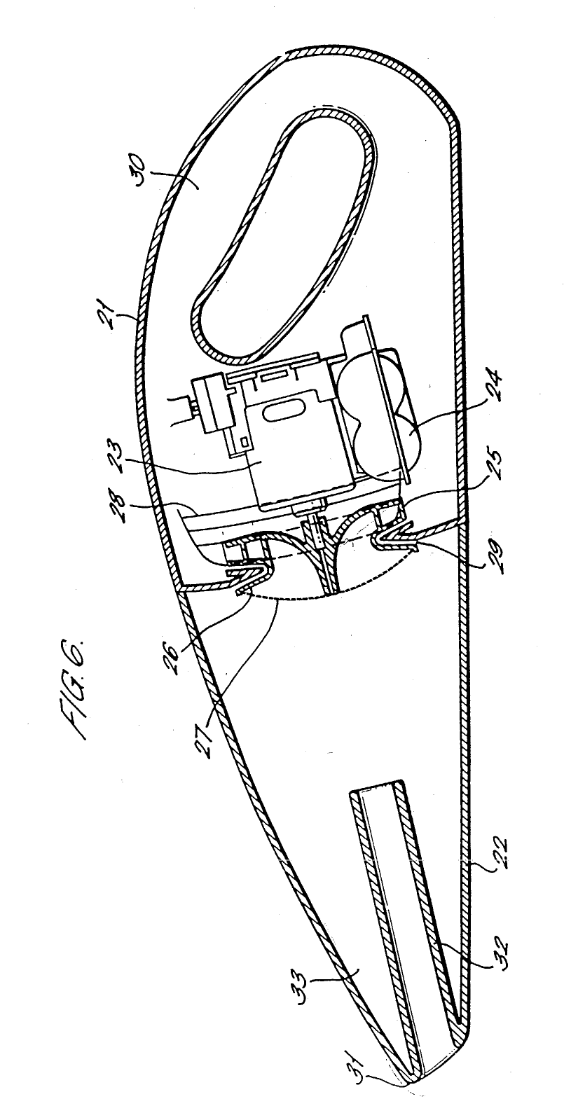

FIG. 4 is a diagrammatic representation in section of a device similar to that of FIG. 3 showing in more detail the recovery of particulate matter and recirculation of diverted fluid, including the fluid flows and particular points in the system which are referred to in FIG. 5;

FIG. 5 is a Mollier diagram of the device of FIG. 4.

FIG. 6 is a diagrammatic representation, partially in section, or a hand-held vacuum cleaner incorporating the device of the invention.

Referring to FIG. 1, the particle laden fluid 12 approaches the rotating filter disc 1 where particles 2 unable to pass with the fluid stream 3 are thrown off the rotating disc 1 by tangential forces as shown by the direction arrow. The flow of fluid through the rotating filter is created by the application of a differential pressure (p¹-p⁰) which may be provided by any suitable means.

Suitable means for providing a differential pressure across the rotating filter 1 may themselves rotate providing a suitable and integrated drive means for the disc 1. FIGS. 2 and 3 show two suitable turbo-machinery means, FIG. 2 an axial machine and FIG. 3 a radial or centrifugal machine. In both cases the disc is rotated directly by the machine and forms an integral part of the rotor 4 for the axial machine and rotor 5 for the radial or centrifugal machine, respectively. The operation of the rotating filter disc 1 is as previously described with the fluid 3 passing through the filter 1 and the blading of the rotors 4 and 5 respectively being clean of particulate matter 2; the filter disc also remaining clean.

In those situations where particulate free fluid is the required product the particles 2 may be hit off the rotating filter disc 1, guided to a place where they will not become caught up in or interfere with the incoming flow but may not be recovered. In other situations such as those of a vacuum cleaner it is necessary to recover the particles 2 that are struck off the rotating filter disc 1. Referring to FIG. 4, dirty fluid 12 containing particles 2 enters a duct 14 at point A induced by the action of the centrifugal machine impeller 5. This fluid is drawn through duct 14 onto the face of the rotating filter disc 1. Clean fluid 3 is drawn by centrifugal action in rotor 5 through the rotating filter 1 to be exhausted into a suitable duct 11 at point E. Particles 2 striking the rotating filter 1 are thrown off as described above to be carried by the diverted fluid flow 6 induced by the action of the shrouded rotating disc 1 to point F in a suitable volute duct formed with the shroud 7. From F the fluid and particles pass to G in a suitable container where with lower fluid velocity a proportion of the particles 13 settle out for example under the influence of gravity. The partially cleaned fluid 15 passes through duct 9 to rejoin the main stream 12 at H.

The flow conditions of the incoming stream 12, 10, the clean stream 3, 11 and the particulate laden stream 6 and the recycle stream 15, are shown in the Mollier Diagram of FIG. 5.

The precise configuration of the rotating disc is dependent on the detailed flow conditions and geometry of the main dirty flow 12 and the cleaned flow 3 which are themselves dependent on the particular application.

FIG. 6 shows partially diagrammatically a hand-held vacuum cleaner which incorporates a device according to the present invention. This vacuum cleaner is in fact an adaptation of the well-known “Dustbuster” (Trade Mark) type of hand-held vacuum cleaner which has been modified in the manner described earlier.

The cleaner comprises a main portion (21) and a detachable nozzle portion (22) which exteriorly comprise two housings of moulded plastic material. The main portion (21) houses an electric motor (23) which has switch means (not shown). The electric motor is powered by rechargeable batteries (24) and drives an impeller (25) which is integral with funnel-shaped conduit (26) at the front of which is fitted a dome-shaped perforated barrier of metal mesh (27). The housing (21) has exhaust vents (28) on each side to carry away the main stream of air produced by the impeller. Additionally, however, there is a circumferential gap (29) between the circumferential neck of the funnel-shaped conduit (26) and the impeller (25), and the wall of the main housing (21) which faces the nozzle portion (22). A function of this gap is to permit a portion of the airstream which has passed through the perforated barrier and the impeller to be fed back around the barrier to join the diverted portion of airstream containing the entrained separated particulate material.

The detachable nozzle portion (22) has a nozzle (31) which leads into an internal conduit (32) for conveying air with particulate material entrained therein. The presence of the internal conduit (32) provides an annular space (33) in which separated particulate material can collect.

It will be seen that the device shown in FIG. 6 operates in much the same way as the device shown at the right hand side of FIG. 4 as described previously, except that instead of the diverted portion of the fluid stream containing separated particles being conducted by means of a shroud and a duct to a Solute duct and/or a separate container for the particles, in the device of FIG. 6 the diverted stream is contained within the detachable nozzle portion (22) and the particles can collect in the annular space (33). When the nozzle portion (22) contains a substantial amount of particulate material it can be detached from the main portion (21), shaken or otherwise treated to remove particles from the nozzle portion and then re-fitted to the main portion of the cleaner for re-use.

It should be noted that although pressure differences are an essential part of the operation of the method and device of the invention as exemplified above it is possible, as explained earlier, to balance the pressures within the device so that there is a backflow of fluid from behind the filter to join the diverted stream, so that no pressure seals are necessary and no clogging of the gap with particulate material occurs.

1. A method of separating particulate material (2) from a fluid stream (12) which method comprises rotating in the fluid stream (12) a barrier comprising a perforated disc (1, 27) which permits the fluid to pass through it, the axis of rotation of the disc (1, 27) projecting into the fluid stream (12), and the front face of the perforated disc (1, 27) being substantially perpendicular to the streamlines in a major part of the incoming stream (12) at the points where the stream meets the front face of the disc (1, 27), particles (2) colliding with the disc (1, 27) being in consequence imparted with kinetic energy in a tangential direction so that they travel across the front face of the disc towards the periphery of the perforated disc (1, 27) entrained in a diverted portion (6) of the fluid stream, the method further including guiding the diverted portion (6) of the fluid stream to a place (8) where it is separate from the vicinity of the rotating front face of the disc (1, 27).

2. A method as claimed in claim 1 wherein a portion of the fluid stream which has passed through the perforated disc (1, 27) is fed back around the disc (1, 27) to join the diverted portion (6) of the fluid stream containing the entrained separated particulate material (2).

3. A method as claimed in any one of the preceding claims wherein the means (4, 5, 23, 25) for causing rotation of the perforated disc (1, 27) also includes means for inducing the flow of the fluid stream.

4. A method as claimed in claim 3 wherein the disc (1, 27) is rotated by a turbo-machine (4, 5) integral with the disc (1, 27).

5. A method as claimed in any one of the preceding claims wherein the front of the rotating disc (1, 27) is provided with a circumferential shroud (7) to guide the said diverted portion (6) of the stream with the entrained particles (2) therein.

6. A method as claimed in any one of the preceding claims wherein said diverted portion (6) of the stream is conducted to a vessel (8) where at least a part of the solid particles (2) contained therein are separated from the fluid.

7. A method as claimed in any one of the preceding claims wherein at least part of the diverted portion (6) of the stream containing separated solid particles (2) is returned to the incoming fluid stream (12).

8. A method as claimed in any one of the preceding claims wherein particulate matter (2) is added to the incoming fluid stream (12).

9. A method as claimed in any one of the preceding claims wherein the fluid stream (12) containing the particulate material (2) is prepared by directing a stream of the fluid at the particulate material (2) so as to entrain the material in the stream.

10. A method as claimed in any one of the preceding claims wherein said diverted portion (6) of the fluid stream, optionally after a part of the particulate material (2) has been removed therefrom, is introduced into a chemical or physical process for transforming the particles (2).

11. A method as claimed in any one of the preceding claims wherein the fluid is gaseous and wherein a liquid fluid, for example water, is introduced into the fluid stream.

12. A method of removing noxious particulate material from a fluid, comprising a method as claimed in any one of the preceding claims.

13. A method of removing particulate waste material, comprising a method as claimed in any one of the preceding claims.

14. A method of isolating a desired particulate material, comprising a method as claimed in any one of claims 1 to 9.

15. A device for separating particulate material (2) from a fluid stream (12), which device comprises:
a duct (14) for conveying a fluid stream (12) containing entrained particulate material (2);
a barrier comprising a perforated disc (1, 27) which is mounted for rotation about an axis which projects into the fluid stream (12), said perforated disc (1, 27) permitting fluid flow through it, the front face of the disc (1, 27) being arranged such that fluid is drawn through the duct onto the front face of the disc (1, 27), and so that the front face is substantially perpendicular to the streamlines in a major part of the incoming stream at the points where the stream meets the front fact of the disc (1, 27);
a means (7) for guiding across the front face of the disc a diverted portion (6) of the fluid stream which contains particles (2) which have collided with the front surface of the disc (1, 27) and in consequence have been imparted with kinetic energy in a tangential direction by the rotation of the disc (1, 27), so that said particles (2) are entrained in said diverted portion (6) of the fluid stream; said guiding means (7) being arranged to guide said diverted portion (6) of the stream to a place (8) where it is separate from the vicinity of the rotating front surface of the disc (1, 27); and
means for rotating the perforated disc.

16. A device as claimed in claim 15 further comprising means for feeding back a portion of the fluid stream which has passed through the disc (1, 27) to join the diverted portion (6) of the fluid stream containing entrained separated particulate material (2).

17. A device as claimed in claims 15 or 16 wherein the means (4, 5, 23, 25) for rotating the disc also includes means for inducing the flow of the fluid.

18. A device as claimed in claim 17 wherein the perforated disc (1, 27) is integral with an impeller.

19. A device as claimed in any one of claims 15 to 18 which includes a circumferential guiding shroud (7) at the front of the rotatable disc (1, 27), which is either fixed or rotates with the disc.

20. A device as claimed in any one of claims 15 to 19 which comprises a duct (9). operably connected to conduct a directed flow of fluid containing particulate material from the front of the perforated disc to a receptacle (8).

21. Vacuum cleaning equipment comprising a device as claimed in any one of claims 15 to 20.

22. Fluid treatment equipment for removal of noxious particulate matter including a device as claimed in any one of claims 15 to 20.

23. A device for attachment to the exhaust system of a combustion engine for removal of particles from the emission, consisting of or comprising a device as claimed in any one of claims 15 to 20.
